(19) United States
(12) Patent Application Publication
(10) Pub. No.: US 2018/0037366 A1
(43) Pub. Date: Feb. 8, 2018

(54) ANTI-SOG SANDWICH BOX

(71) Applicants: Grace Qian, Herndon, VA (US); Feng Qian, Herndon, VA (US)

(72) Inventors: Grace Qian, Herndon, VA (US); Feng Qian, Herndon, VA (US)

(21) Appl. No.: 15/228,287

(22) Filed: Aug. 4, 2016

(51) Int. Cl. B65D 25/04; A47J 47/08; B65D 43/02; B65B 7/28; B65B 61/20

(52) U.S. Cl. CPC B65D 25/04; B65B 7/28; B65B 61/207; B65D 43/02; A47J 47/08

(57) ABSTRACT

Provided herein is a container for storing and transporting a sandwich. The container includes separate compartments for storing the sandwich components to prevent the bread from becoming soggy due to wetter ingredients. Removable dividers in between the compartments allow for easy and automatic assembly of the sandwich within the container prior to consumption.

### FIELD OF THE INVENTION

The invention is generally related to a container for storing and transporting a sandwich that prevents the bread from contacting wetter ingredients until the time for consumption. Removable barriers in between the compartments of the container allow for simple assembly of the sandwich within the container.

### BACKGROUND OF THE INVENTION

The sandwich has been a popular and portable meal for individuals, both workers and students alike, for decades. However, if the sandwich is prepared some time before consumption (e.g. prepared in the morning for lunch later in the afternoon), the sandwich tends to become soggy which makes the meal less appealing. As soon as the sandwich is assembled, the ingredients begin interacting with each other and a dry piece of bread will begin to absorb the moisture from the vegetables, meats, and/or condiments, thus losing its structure and becoming soggy.

As described in U.S. Patent application 2013/0180217, others have attempted to solve this problem by providing a container with two or more compartments: one for bread and one or more for additional sandwich components. However, these containers require the user remove all of the sandwich components individually and build the sandwich themselves prior to eating.

Thus, a container that keeps bread dry as a sandwich is stored and transported while avoiding the awkwardness of assembling a sandwich prior to consumption is needed.

### SUMMARY OF THE INVENTION

An aspect of the invention relates to a container for storing and transporting a sandwich in a disassembled state such that the sandwich can be self-assembled when one is ready to consume it. The container comprises at least three compartments for separating sandwich ingredients, a removable barrier in between each pair of adjacent compartments of said at least three compartments, wherein, when inserted, the removable barrier forms the upper surface of a first compartment and the lower surface of a second compartment and wherein the removable barrier is configured to be removable through a side of the container, and a removable lid that covers the topmost compartment.

In some embodiments, the container has an upper compartment, a lower compartment, a middle compartment, a first removable barrier between the upper and middle compartments and a second removable barrier between the middle and lower compartments. A portion of the removable barrier can extend beyond the boundary of the at least two compartments. The container may be made of plastic, cardboard, or other suitable materials. In some embodiments, the cardboard is provided as a flat sheet with markings for cutting and assembling the container.

Another aspect of the invention provides a method of storing and assembling a sandwich, comprising the steps of placing sandwich ingredients into a container, said container comprising at least two compartments for separating sandwich ingredients, a removable barrier in between each of said at least two compartments, wherein, when inserted, the removable barrier forms the upper surface of a first compartment and the lower surface of a second compartment and wherein the removable barrier is configured to be removable through a side of the container, and a removable lid that covers the topmost compartment; and removing said removable barrier to assemble the sandwich before consumption.

In some embodiments, the placing step is performed by: placing a first piece of bread in the lower compartment; inserting the first removable barrier to form an upper surface of the lower compartment and a lower surface of the middle compartment; placing sandwich ingredients other than bread into the middle compartment; inserting the second removable barrier to form an upper surface of the middle compartment and a lower surface of the upper compartment; placing a second piece of bread in the upper compartment; and placing the lid on top of the upper compartment.

In further embodiments, a portion of the removable barrier extends beyond the boundary of the at least two compartments and said portion is used to remove the removable barrier to assemble the sandwich before consumption. If the container is made of cardboard, the cardboard can be provided as a flat sheet with markings and the cardboard is cut and assembled prior to placing the sandwich ingredients into the container.

### BRIEF DESCRIPTION OF THE DRAWINGS

FIG. 1A-C. An exemplary embodiment of a plastic container of the invention is shown (A) fully assembled; (B) with the lid and two barriers removed; and (C) in a side view fully assembled.

FIG. 2. An alternative embodiment to FIGS. 1A-C shown in triangular configuration.

FIG. 3A-D. An exemplary embodiment of a cardboard container of the invention is shown (A) fully assembled; (B) assembled with the lid open; (C) in a side view fully assembled; and (D) with the lid open and two barriers removed.

### DETAILED DESCRIPTION

The invention provides a sandwich container with removable barriers that prevents the bread from becoming soggy during storage and transport while allowing for the simple self-assembly of the sandwich within the container prior to eating. The container is also useful for protecting the sandwich from being flattened and from losing its freshness.

As used herein, a “sandwich” is a food item consisting of one or more types of food, such as vegetables, sliced cheese, or meat, placed on or between slices of bread, or more generally any dish wherein bread serves as a container or wrapper for some other food, such as deli meat or a burger. In some embodiments, the sandwich includes at least two pieces of bread. In other embodiments, the sandwich includes one piece of bread that may be wrapped around the filling of the sandwich (e.g., a taco). Sandwiches are a portable type of food, that can be taken to work, school, or picnics to be eaten as part of a packed lunch. The bread can be used plain, or it can be coated with one or more condiments such as mayonnaise or mustard to enhance the flavors and texture. As well as being homemade, sandwiches may also be sold in restaurants, cafes, vending machines, etc. and are sometimes served hot as well as cold.

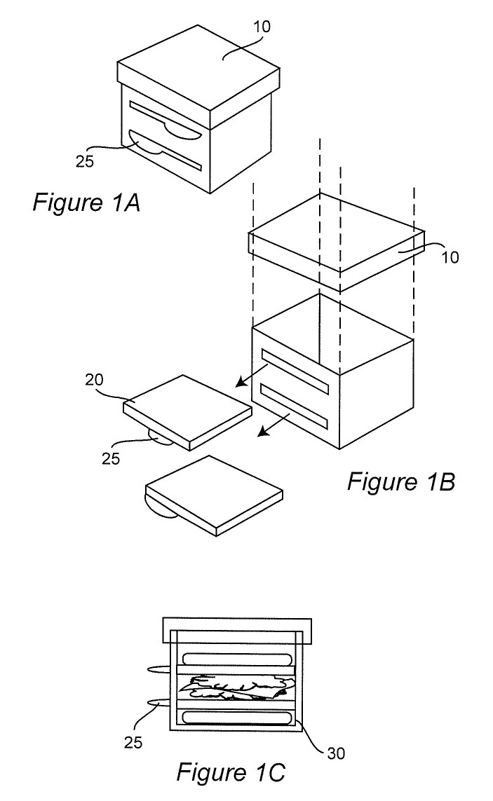

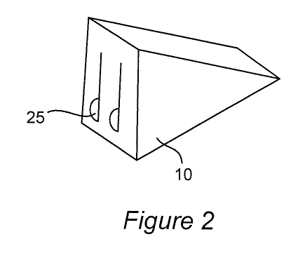

In some embodiments, the container comprises at least three compartments for separating sandwich ingredients. As shown in FIGS. 1A-C, 2, and 3A-D, the container may contain three compartments 30: an upper compartment, a lower compartment, and a middle compartment. While FIG. 1A shows the container in a substantially square shape, the container can also be implemented in a half-sandwich configuration as shown in FIG. 2. A slice of bread may be placed in the upper and lower compartments while the remaining sandwich ingredients are placed in the middle compartment. In other embodiments, the container has two, four, five, six, or more compartments which allows for further separation of the sandwich ingredients. For example, the bread, vegetables, meat, and cheese may each be placed in a separate compartment.

The container may be formed from plastic, cardboard, or any other suitable material or combination thereof (e.g. to provide a dishwasher- and/or microwave-safe container). In some embodiments, the cardboard is provided as a flat sheet with markings for cutting and assembling/folding the container. The container may be reusable or provided for one-time use. In preferred embodiments, the containers described herein are substantially sized and configured for sandwiches (e.g. substantially square or circular; or in the shape of a sub sandwich), however, the use of containers of the invention is not limited to merely sandwiches. Therefore, the containers described herein are not limited to sandwiches and can be used to house any food product.

The container of the invention includes a thin removable barrier or divider 20 in between each of the compartments 30, wherein, when inserted, the removable barrier 20 forms the upper surface of a first compartment and the lower surface of a second compartment. The removable barrier is configured to be removable through a side of the container. Therefore, in some embodiments, a portion 25 of the removable barrier (e.g. a tab) extends beyond the boundary of the compartments. A user can simply grasp these tabs and slide the barriers out of a side or front of the container to assemble the sandwich within the container before consumption.

When inserted, the barrier or divider can prevent cross contamination even if the container is upended or jostled between the time it is packed and when it is unpacked (i.e. the wet ingredients are kept separated from the dry ingredients). Cross-contamination may be prevented by providing a barrier of a size such that it contacts all four sides of the container. In some embodiments, the interior of the container may contain notches for insertion of the barrier thus providing a more effective seal between compartments.

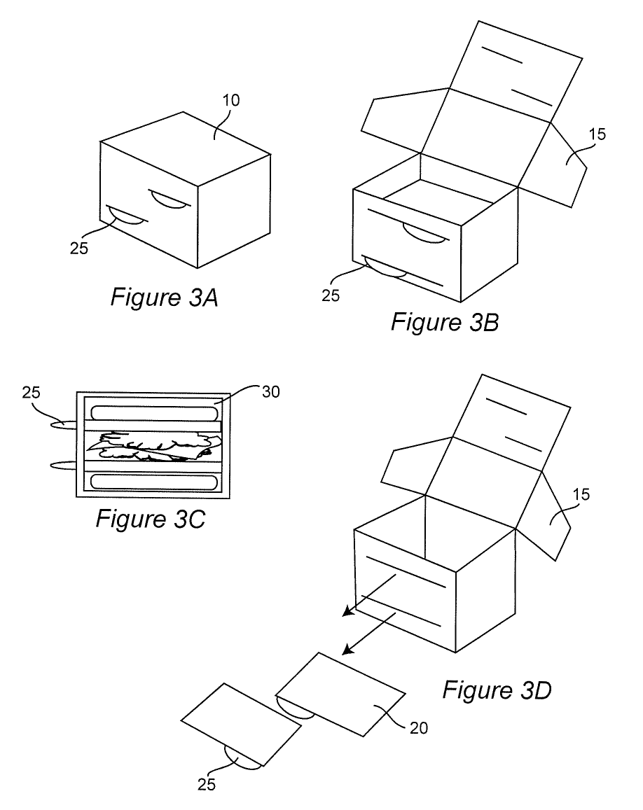

The container also includes a removable lid 10 that covers the topmost compartment. The lid may be completely detachable from the container and configured to snap onto the top of the container (FIG. 1) or hingedly connected on one side of the container (FIG. 3). When the container is formed from cardboard, the lid may include flaps 15 that fold into the interior of the container (e.g. side flaps fold into either side of the container and a front flap that folds into the front of the container while still allowing the tabs of the barriers to protrude from the container).

Another aspect of the invention provides a method of storing and assembling a sandwich, comprising the steps of placing sandwich ingredients into a container as described herein and removing the removable barrier to assemble the sandwich before consumption. In some embodiments, the placing step is performed by: placing a first piece of bread in the lower compartment; inserting the first removable barrier to form an upper surface of the lower compartment and a lower surface of the middle compartment; placing sandwich ingredients other than bread into the middle compartment; inserting the second removable barrier to form an upper surface of the middle compartment and a lower surface of the upper compartment; placing a second piece of bread in the upper compartment; and placing the lid on top of the upper compartment. It should be understood that the method of the invention is carried out in substantially the same manner regardless of the number of compartments, in that the compartments will be filled with ingredients from the bottom to the topmost compartment.

The container may contain heating and/or cooling pads either as part of the removable barriers or as additional compartments surrounding the exterior of the container for keeping meats warm and/or keeping vegetables cool. One skilled in the arts would appreciate that heating and cooling pads may be passive thermal reservoirs, active electrical components, chemical components, or other means of maintaining a desired temperature range above or below the environment surrounding the container. One skilled in the art would also understand that the temperature differences may be enhanced and/or retained for longer periods of time by the use of different materials for construction of the pads, compartments, or the use of additional insulation between the desired compartment and the others, or the outside environment.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A container for storing a sandwich, comprising:
at least three compartments for separating sandwich ingredients,
a removable barrier in between each pair of adjacent compartments of said at least three compartments, wherein, when inserted, the removable barrier forms the upper surface of a first compartment and the lower surface of a second compartment and wherein the removable barrier is configured to be removable through a side of the container, and
a removable lid that covers the topmost compartment.

2. The container of claim 1, wherein the container has an upper compartment, a lower compartment, a middle compartment, a first removable barrier between the upper and middle compartments and a second removable barrier between the middle and lower compartments.

3. The container of claim 1, wherein a portion of the removable barrier extends beyond the boundary of the at least two compartments.

4. The container of claim 1, wherein the container is made of plastic.

5. The container of claim 1, wherein the container is made of cardboard.

6. The container of claim 5, wherein the cardboard is provided as a flat sheet with markings for cutting and assembling the container.

7. A method of storing and assembling a sandwich, comprising the steps of:
placing sandwich ingredients into a container, said container comprising
at least three compartments for separating sandwich ingredients,
a removable barrier in between each pair of adjacent compartments of said at least three compartments, wherein, when inserted, the removable barrier forms the upper surface of a first compartment and the lower surface of a second compartment and wherein the removable barrier is configured to be removable through a side of the container, and
a removable lid that covers the topmost compartment; and
removing said removable barrier to assemble the sandwich before consumption.

8. The method of claim 7, wherein the container has an upper compartment, a lower compartment, a middle compartment, a first removable barrier between the upper and middle compartments and a second removable barrier between the middle and lower compartments.

9. The method of claim 8, wherein, said placing step is performed by:
placing a first piece of bread in the lower compartment;
inserting the first removable barrier to form an upper surface of the lower compartment and a lower surface of the middle compartment;
placing sandwich ingredients other than bread into the middle compartment;
inserting the second removable barrier to form an upper surface of the middle compartment and a lower surface of the upper compartment;
placing a second piece of bread in the upper compartment; and
placing the lid on top of the upper compartment.

10. The method of claim 7, wherein a portion of the removable barrier extends beyond the boundary of the at least two compartments and said portion is used to remove the removable barrier.

11. The method of claim 7, wherein the container is made of plastic.

12. The method of claim 7, wherein the container is made of cardboard.

13. The method of claim 12, wherein the cardboard is provided as a flat sheet with markings and the cardboard is cut and assembled prior to said placing step.
